(19) United States
(12) Patent Application Publication
(10) Pub. No.: US 2004/0126119 A1
(43) Pub. Date: Jul. 1, 2004

(54) Method and apparatus for providing a terminal independent interface between a terrestrial optical terminal and an undersea optical transmission path

(76) Inventors: Stephen G. Evangelides JR., Red Bank, NJ (US); Jay P. Morreale, Summit, NJ (US); Michael J. Neubelt, Little Silver, NJ (US); Mark K. Young, Monmouth Junction, NJ (US); Jonathan A. Nagel, Brooklyn, NY (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/621,028

(22) Filed: Jul. 16, 2003

Related U.S. Application Data
(60) Provisional application No. 60/404,615, filed on Aug. 20, 2002.

(51) Int. Cl. H04B 10/00

(52) U.S. Cl. 398/158

(57) ABSTRACT

An optical transmission system has an optical transmission terminal with first and second optical interfaces. The first interface is configured to communicate in accordance with an industry-standard, network level protocol. The second interface is configured to communicate in accordance with a first optical layer transport protocol. The optical transmission span includes an optical interface device that has a third interface communicating with the second interface of the optical transmission terminal in accordance with the first optical layer transport protocol and a fourth interface configured to communicate in accordance with a second optical layer transport protocol. The optical interface device also has a signal processing unit for transforming optical signals between the first and second optical layer transport protocols. The optical transmission span also includes an optical transmission path optically coupled to the fourth optical interface of the optical interface device for transmitting optical signals in accordance with the second optical layer transport protocol.

### STATEMENT OF RELATED APPLICATIONS

This application claims the benefit of priority to U.S. Provisional Patent Application No. 60/404,615, filed Aug. 20, 2002, entitled “Terminal Independent Interface.”

This application is also related to co-pending U.S. Patent Application No. ______ [Docket No. 9005/19] filed on even date herewith, entitled “Method And Apparatus For Performing System Monitoring In A Terminal Independent Interface Located Between A Terrestrial Optical Terminal And An Undersea Optical Transmission Path.”

### FIELD OF THE INVENTION

The present invention relates generally to optical transmission systems, and more particularly to an optical interface for providing communication between a terrestrial optical terminal and an undersea optical transmission path.

### BACKGROUND OF THE INVENTION

Terrestrial optical transmission networks serving as high-speed backbone networks have for some time now employed the SONET/SDH standards, which is an interface that was established for interconnecting optical transmission equipment from different suppliers. As shown in FIG. 3, optical terminals supplied by various vendors can communicate with one another using customer interfaces that conform to SONET/SDH. Such terminals generally also include a proprietary interface that allows a given vendor to interconnect their own optical terminals without the limitations imposed by SONET/SDH. The proprietary interface communicates over an optical layer transport protocol that is proprietary to the vendor and which depends on parameters such as system length and capacity.

One type of highly specialized optical transmission network are undersea or submarine optical transmission systems in which a cable containing optical fibers is installed on the ocean floor. The design of such optical transmission systems is generally customized on a system-by-system basis and employ highly specialized terminals to transmit data over the undersea optical transmission path. Since the specialized terminals are produced in small volumes they are relatively expensive in comparison to the optical terminals that are designed to communicate over terrestrial optical layer protocols, which are typically produced in relatively high volume for terrestrial optical transmission networks.

The terrestrial terminals are generally not employed over undersea transmission paths because of various limitations imposed by the terrestrial optical layer transport protocols. These limitations include the relatively short spans or links that terrestrial optical layer protocols support, optimization for TDM traffic rather than WDM traffic, a network management scheme that assumes there is readily available access to the equipment along the transmission path, a lack of functions to effectively manage traffic other than traditional voice traffic based on TDM technology, an inefficient use of bandwidth to provide protection circuitry, as well as other inherent limitations in managing and supporting high bandwidth optical networks.

Accordingly, while it would clearly be desirable to use readily available terrestrial optical terminals in undersea transmission systems to reduce costs, terrestrial optical terminals generally do not provide the optical layer functionality required by undersea transmission systems.

### SUMMARY OF THE INVENTION

In accordance with the present invention, an optical transmission span is provided, which is incorporated in an optical transmission system. The optical transmission system has an optical transmission terminal with first and second optical interfaces. The first interface is configured to communicate in accordance with an industry-standard, network level protocol. The second interface is configured to communicate in accordance with a first optical layer transport protocol. The optical transmission span includes an optical interface device that has a third interface communicating with the second interface of the optical transmission terminal in accordance with the first optical layer transport protocol and a fourth interface configured to communicate in accordance with a second optical layer transport protocol. The optical interface device also has a signal processing unit for transforming optical signals between the first and second optical layer transport protocols. The optical transmission span also includes an optical transmission path optically coupled to the fourth optical interface of the optical interface device for transmitting optical signals in accordance with the second optical layer transport protocol.

In accordance with one aspect of the invention, the third and fourth interfaces are bidirectional interfaces.

In accordance with another aspect of the invention, the industry-standard, network level protocol is SONET/SDH.

In accordance with another aspect of the invention, the industry-standard, network level protocol is ATM.

In accordance with another aspect of the invention, the industry-standard, network level protocol is Gigabit Ethernet.

In accordance with another aspect of the invention, the second optical layer transport protocol includes wavelength division multiplexing.

In accordance with another aspect of the invention, the second optical layer transport protocol supports at least one signal process selected from the group consisting of gain equalization, bulk dispersion compensation, optical gain, Raman amplification, dispersion slope compensation, PMD compensation, and performance monitoring.

In accordance with another aspect of the invention, the optical transmission path is an undersea optical transmission path.

In accordance with another aspect of the invention, a method is provided for transmitting an optical signal. The method begins by receiving an optical signal in accordance with a first optical layer transport protocol from an optical transmission terminal having first and second optical interfaces. The first interface is configured to communicate in accordance with an industry-standard, network level protocol. The second interface is configured to communicate in accordance with the first optical layer transport protocol. The optical signal is transformed so that it is in conformance with a second optical layer transport protocol and the transformed optical signal is directed through an optical transmission path in accordance with the second optical layer transport protocol.

### BRIEF DESCRIPTION OF THE DRAWINGS

FIG. 1 shows the various layers of the OSI network hierarchy and its correspondence to SONET/SDH.

FIG. 2 shows the layers of a SONET/SDH over optical layer network.

FIG. 3 shows a conventional link in a SONET/SDH network as typically employed in terrestrial optical networks.

FIG. 4 shows a block diagram of the network architecture constructed in accordance with the present invention.

FIG. 5 shows a block diagram of one embodiment of the inventive optical interface device depicted in FIG. 4.

### DETAILED DESCRIPTION

The present inventors have recognized that specialized undersea optical terminals are often not required for undersea transmission systems. Rather, less expensive, readily available terrestrial optical terminals can be used by providing an appropriate interface between the terrestrial terminals and the undersea transmission path. The interface provides high compatibility between the proprietary interface of terrestrial optical terminals available from multiple vendors and the undersea transmission path. That is, the interface is designed to be terminal independent and serves as an interface between terrestrial optical layer transport protocols and an undersea optical layer transport protocol. Examples of terrestrial optical terminals that are currently available and which may be used in connection with the present invention include, but are not limited to, the Nortel LH1600 and LH4000, Siemens MTS 2, Cisco 15808 and the Ciena CoreStream long-haul transport products.

To facilitate a better understanding of the present invention, an overview of network protocols will be presented below. Additional details may be found, for example, in Chapter 6 of Optical Networks: A Practical Perspective, R. Ramaswami and K. Sivarajan, Academic Press, 1998, which is hereby incorporated by reference in its entirety.

### Network Protocols

Networks almost universally employ multiple layers of protocols. A low-level physical layer protocol assures the transmission and reception of a data stream between two devices. Data packets are constructed in a data link layer. Over the physical layer, a network and transport layer protocol governs transmission of data through the network, thereby ensuring end-to end reliable data delivery.

As computer and transmission networks have developed, various approaches have been used in the choice of communication medium, network topology, message format, protocols for channel access, and so forth. Some of these approaches have emerged as de facto standards, but there is still no single standard for network communication. However, a model for network architectures has been proposed and widely accepted. It is known as the International Standards Organization (ISO) Open Systems Interconnection (OSI) reference model. The OSI reference model is not itself a network architecture. Rather it specifies a hierarchy of protocol layers and defines the function of each layer in the network. Each layer in one node of the network carries on a conversation with the corresponding layer in another node with which communication is taking place, in accordance with a protocol defining the rules of this communication. In reality, information is transferred down from layer to layer in one node, then through the channel medium and back up the successive layers of the other node. However, for purposes of design of the various layers and understanding their functions, it is easier to consider each of the layers as communicating with its counterpart at the same level, in a “horizontal” direction.

The lowest layer defined by the OSI model is called the physical layer, and is concerned with transmitting raw data bits over the communication channel. Design of the physical layer involves issues of electrical, mechanical or optical engineering, depending on the medium used for the communication channel. The layer next to the physical layer is called the data link layer. The main task of the data link layer is to transform the physical layer, which interfaces directly with the channel medium, into a communication link that appears error-free to the next layer above, known as the network layer. The data link layer performs such functions as structuring data into packets or frames, and attaching control information to the packets or frames, such as checksums for error detection, and packet numbers. The network layer performs the end-to-end routing function of taking a message at its source and delivering it to its destination. Above the network layer are the transport, session, presentation, and application layers.

### SONET/SDH and Optical Layer Protocols

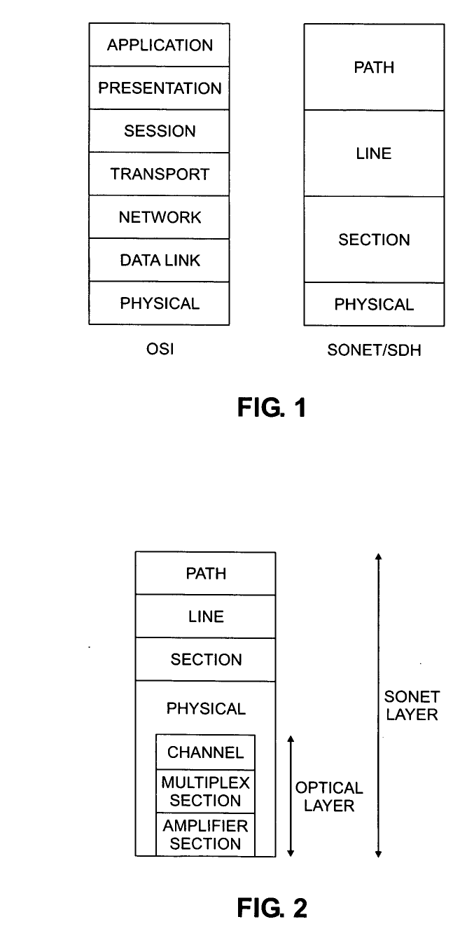

The SONET/SDH standards provide an interface to a network level protocol that consists of four layers. These layers are combinations and derivatives of the seven-layer OSI model. A rough correspondence between the seven layers of the OSI model and SONET/SDH is shown in FIG. 1. The path layer is responsible for monitoring and tracking end-to-end connections between nodes. The line layer multiplexes a number of path layer connections onto a single link between two nodes. Each link is divided into a number of sections, which correspond to link segments between regenerators. The physical layer is responsible for the actual transmission of bits across the fiber.

The International Telecommunications Union (ITU) has recently defined a new layer, the optical layer, which corresponds to the physical layer in the OSI model. The breakdown of the optical layer into its various sublayers is described in ITU recommendation G.681. As shown in FIG. 2, the optical layer in turn consists of three sublayers, the optical channel layer, the optical multiplex section and the optical amplifier section. The optical layer is responsible for end-to-end routing of a lightpath (i.e., an end to-end connection using a single wavelength on each link). The optical multiplex section layer is used to represent a point-to-point link along the route of a lightpath. The optical amplifier section layer controls the links between optical amplifiers.

In a realistic network, two or more of the above-mentioned protocol stacks may reside one on top of the other. For example, a SONET/SDH over optical layer network is shown in FIG. 2. In this case the SONET/SDH network treats the optical layer network as its physical layer. That is, the physical layer of SONET/SDH is replaced with the optical layer.

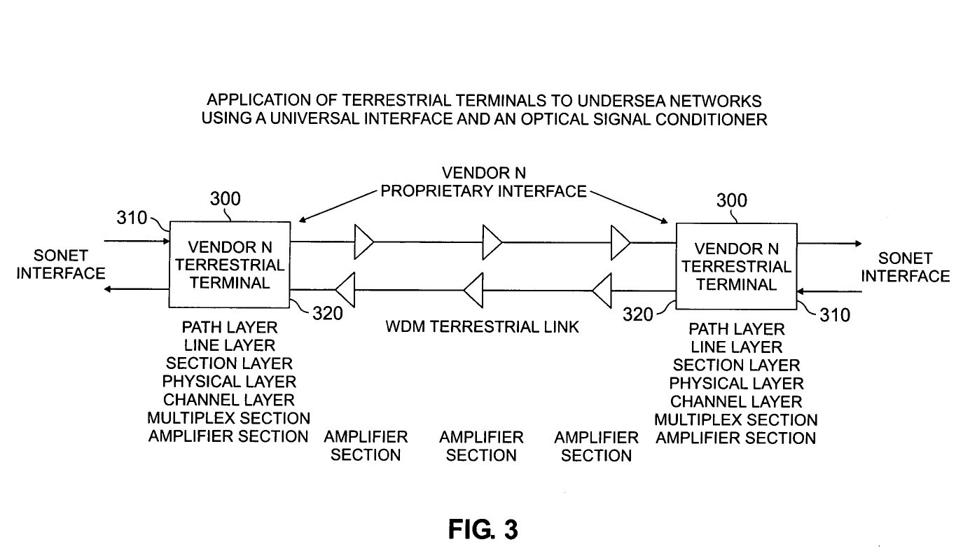

FIG. 3 shows a conventional link in a SONET/SDH network as typically employed in terrestrial optical networks. The link consists of two SONET/SDH terminals 300 that are provided by a single vendor. The terminals have SONET/SDH interfaces 310 that allow them to interconnect with customer equipment and transmission equipment from different suppliers. The terminals also include a proprietary interface 320 that allows a given vendor to interconnect their own optical terminals without the limitations imposed by SONET/SDH. The proprietary interface communicates over an optical layer transport protocol that is proprietary to the vendor. Directly below the terminals 300 in FIG. 3 are shown the layers employed by the terminal interfaces. The SONET/SDH interface 310 is shown in terms of the SONET/SDH over optical layer network seen in FIG. 2.

### Optical Interface

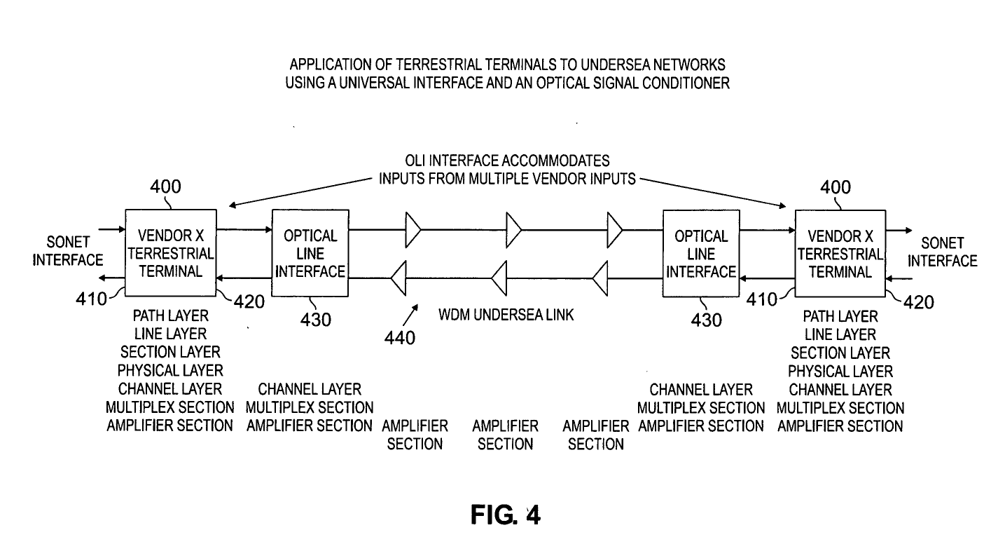

The present inventors have recognized that an undersea communication system may replace the specialized terminals that are typically employed with less expensive, commercially available, SONET/SDH terminals. This can be accomplished by replacing, on the proprietary interface side, the physical layer of the SONET/SDH terminals with an optical layer transport protocol that is more appropriate for undersea systems. The SONET/SDH terminals are equipped with an interface such as an adaptor card that allows it to communicate with the optical layer transport protocol employed in the undersea communication path. FIG. 4 shows a block diagram of the inventive network architecture.

In FIG. 4 the proprietary, optical layer interfaces 420 of the SONET/SDH terminals 400 communicate over an undersea optical transmission path 440 that provides optical layer functionality. An optical interface device 430 provides the connectivity between the SONET/SDH terminals 400 and the undersea optical transmission path 440. That is, the undersea optical transmission path 440 is transparent to the SONET/SDH terminals 400 so that from their perspective they are communicating over their own proprietary links.

The optical interface device 430 receives the optical signals from the optical layer interface 420 of the SONET/SDH terminals 400. The interface device 430 provides the optical layer signal conditioning that is not provided by the SONET/SDH terminals 400, but which is necessary to transmit the optical signals over the undersea transmission path 440. The signal conditioning that is provided may include, but is not limited to, gain equalization, bulk dispersion compensation, optical gain, Raman amplification, dispersion slope compensation, polarization mode dispersion (PMD) compensation, performance monitoring, dummy channel insertion, or any combination thereof. The aforementioned signal conditioning processes generally reside in the optical amplifier section of the optical layer transport protocol shown in FIG. 2. More generally, however, the present invention encompasses an optical interface device that provides signal conditioning at any one or more of the optical sublayers depicted in FIG. 2.

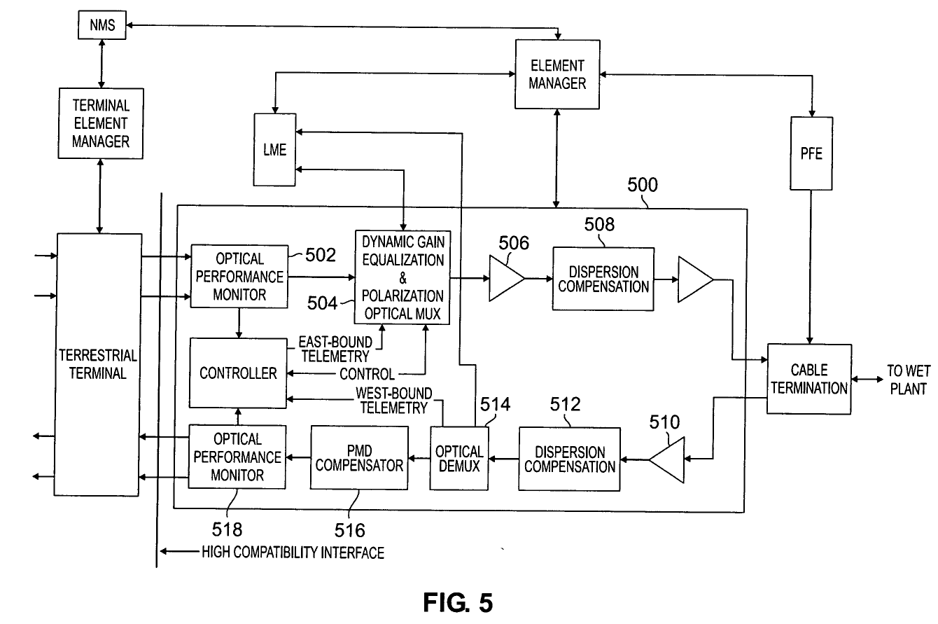

FIG. 5 shows a block diagram of one embodiment of the inventive optical interface device 500 depicted in FIG. 4. The optical signal received from the SONET/SDH terminal is monitored for optical performance by optical performance monitor 502, then power equalized by polarization multiplexer 504, optically amplified by amplifier 506, and passed through a dispersion compensation device 508 such as a dispersion compensating fiber or a grating-based dispersion compensation device, after which the optical signal is ready to traverse the undersea optical transmission path. Likewise, the optical signal received by the interface device 500 from the undersea optical transmission path is optically amplified by amplifier 510, passed through a dispersion compensation device 512, optically demultiplexed by demultiplexer 514, passed through a polarization mode dispersion (PMD) compensator 516, and monitored for performance by optical performance monitor 518.

The optical performance monitors 502 and 518 ensure that appropriate signal quality is maintained. The optical performance monitors 502 and 518 may measure the OSNR, Q-factor, or BER of the optical signal. In operation, a tap or other device directs a small portion of the optical signal to an optical amplifier, filter, and a receiver for converting the optical signal to an electrical signal. A dual channel CDR with an adjustable decision threshold and phase is used to determine the error performance of the data signal. The optical performance information determined by the performance monitor 520 may be used as feedback to control the gain equalizer 504 or the PMD compensator 516.

Although various embodiments are specifically illustrated and described herein, it will be appreciated that modifications and variations of the present invention are covered by the above teachings and are within the purview of the appended claims without departing from the spirit and intended scope of the invention. For example, while the present invention has been described in terms of an interface for terrestrial optical terminals that conform to SONET/SDH standards, the present invention is equally applicable to an interface for terrestrial optical terminals that conform to other industry standard protocols such as ATM and Gigabit Ethernet, for example.

1. In an optical transmission system having an optical transmission terminal with first and second optical interfaces, said first interface being configured to communicate in accordance with an industry-standard, network level protocol, said second interface being configured to communicate in accordance with a first optical layer transport protocol, an optical transmission span comprising:
an optical interface device that includes:
a third interface communicating with the second interface of the optical transmission terminal in accordance with the first optical layer transport protocol;
a fourth interface configured to communicate in accordance with a second optical layer transport protocol; and
a signal processing unit for transforming optical signals between the first and second optical layer transport protocols;
an optical transmission path optically coupled to the fourth optical interface of the optical interface device for transmitting optical signals in accordance with said second optical layer transport protocol.

2. In the optical transmission system of claim 1, an optical transmission span wherein said third and fourth interfaces are bidirectional interfaces.

3. In the optical transmission system of claim 1, an optical transmission span wherein said industry-standard, network level protocol is SONET/SDH.

4. In the optical transmission system of claim 1, an optical transmission span wherein said industry-standard, network level protocol is ATM.

5. In the optical transmission system of claim 1, an optical transmission span wherein said industry-standard, network level protocol is Gigabit Ethernet.

6. In the optical transmission system of claim 1, an optical transmission span wherein said second optical layer transport protocol includes wavelength division multiplexing.

7. In the optical transmission system of claim 1, an optical transmission span wherein said second optical layer transport protocol supports at least one signal process selected from the group consisting of gain equalization, bulk dispersion compensation, optical gain, Raman amplification, dispersion slope compensation, PMD compensation, and performance monitoring.

8. In the optical transmission system of claim 6, an optical transmission span wherein said second optical layer transport protocol supports at least one signal process selected from the group consisting of gain equalization, bulk dispersion compensation, optical gain, Raman amplification, dispersion slope compensation, PMD compensation, and performance monitoring.

9. In the optical transmission system of claim 1, an optical transmission span wherein said optical transmission path is an undersea optical transmission path.

10. In the optical transmission system of claim 9, an optical transmission span wherein said second optical layer transport protocol is configured for said undersea optical transmission path.

11. In the optical transmission system of claim 1, an optical transmission span
wherein said signal processing unit performs at least one process on the optical signals selected from the group consisting of gain equalization, bulk dispersion compensation, optical gain, Raman amplification, dispersion slope compensation, PMD compensation, dummy channel insertion, and performance monitoring.

12. A method of transmitting an optical signal, said method comprising the steps of:
receiving an optical signal in accordance with a first optical layer transport protocol from an optical transmission terminal having first and second optical interfaces, said first interface being configured to communicate in accordance with an industry-standard, network level protocol, said second interface being configured to communicate in accordance with the first optical layer transport protocol;
transforming the optical signal so that it is in conformance with a second optical layer transport protocol; and
directing the transformed optical signal through an optical transmission path in accordance with the second optical layer transport protocol.

13. The method of claim 12 wherein said optical transmission path is a bi-directional transmission path.

14. The method of claim 12 wherein said industry-standard, network level protocol is SONET/SDH.

15. The method of claim 12 wherein said industry-standard, network level protocol is ATM.

16. The method of claim 12 wherein said industry-standard, network level protocol is Gigabit Ethernet.

17. The method of clam 12 wherein said second optical layer transport protocol includes wavelength division multiplexing.

18. The method of claim 12 wherein said second optical layer transport protocol supports at least one signal process selected from the group consisting of gain equalization, bulk dispersion compensation, optical gain, Raman amplification, dispersion slope compensation, PMD compensation, and performance monitoring.

19. The method of claim 17 wherein said second optical layer transport protocol supports at least one signal process selected from the group consisting of gain equalization, bulk dispersion compensation, optical gain, Raman amplification, dispersion slope compensation, PMD compensation, and performance monitoring.

20. The method of claim 12 wherein said optical transmission path is an undersea optical transmission path.

21. The method of claim 20 wherein said second optical layer transport protocol is configured for said undersea optical transmission path.

22. The method of claim 12 wherein said signal processing unit performs at least one process on the optical signals selected from the group consisting of gain equalization, bulk dispersion compensation, optical gain, Raman amplification, dispersion slope compensation, PMD compensation, and performance monitoring.

23. An optical interface device for use in an optical transmission system having an optical transmission terminal with first and second optical interfaces, said first interface being configured to communicate in accordance with an industry-standard, network level protocol, said second interface being configured to communicate in accordance with a first optical layer transport protocol, said optical interface device comprising:
a third interface communicating with the second interface of the optical transmission terminal in accordance with the first optical layer transport protocol;
a fourth interface configured to communicate in accordance with a second optical layer transport protocol; and
a signal processing unit for transforming optical signals between the first and second optical layer transport protocols;
an optical transmission path optically coupled to the fourth optical interface of the optical interface device for transmitting optical signals in accordance with said second optical layer transport protocol.

24. The optical interface device of claim 23 wherein said third and fourth interfaces are bi-directional interfaces.

25. The optical interface device of claim 23 wherein said industry-standard, network level protocol is SONET/SDH.

26. The optical interface device of claim 23 wherein said industry-standard, network level protocol is ATM.

27. The optical interface device of claim 23 wherein said industry-standard, network level protocol is Gigabit Ethernet.

28. The optical interface device of claim 23 wherein said second optical layer transport protocol includes wavelength division multiplexing.

29. The optical interface device of claim 23 wherein said second optical layer transport protocol supports at least one signal process selected from the group consisting of gain equalization, bulk dispersion compensation, optical gain, Raman amplification, dispersion slope compensation, PMD compensation, dummy channel insertion, and performance monitoring.

30. The optical interface device of claim 28 wherein said second optical layer transport protocol supports at least one signal process selected from the group consisting of gain equalization, bulk dispersion compensation, optical gain, Raman amplification, dispersion slope compensation, PMD compensation, and performance monitoring.

31. The optical interface device of claim 23 wherein said optical transmission path is an undersea optical transmission path.

32. The optical interface device of claim 31 wherein said second optical layer transport protocol is configured for said undersea optical transmission path.

33. The optical interface device of claim 23 wherein said signal processing unit performs at least one process on the optical signals selected from the group consisting of gain equalization, bulk dispersion compensation, optical gain, Raman amplification, dispersion slope compensation, PMD compensation, dummy channel insertion and performance monitoring.

34. An optical interface device comprising:
means for receiving an optical signal in accordance with a first terrestrial optical layer transport protocol;
means for transforming the optical signal so that it is in conformance with a second optical layer transport protocol; and
means for directing the transformed optical signal through an optical transmission path in accordance with the second optical layer transport protocol.
